(19) United States
(12) Patent Application Publication
(10) Pub. No.: US 2012/0265589 A1
(43) Pub. Date: Oct. 18, 2012

(54) Method For Collection And Processing For Recycling

(76) Inventor: Frank Whittier, Cumberland, ME (US)

(21) Appl. No.: 13/088,220

(22) Filed: Apr. 15, 2011

(51) Int. Cl. G06Q 30/00

(52) U.S. Cl. 705/14.11

(57) ABSTRACT

A method for recycling recyclable material involving revenue sharing of the value of the recyclable material for individualized users based upon the amount, quality and/or value of the recyclables contributed by each individual user. A system for recycling recyclable material involving a densification apparatus, a processor, and a computer for allowing revenue sharing of the value of recyclable material.

### FIELD OF THE INVENTION

The invention relates to methods and systems for recycling recyclable material involving revenue sharing of the value of the recyclable material.

### BACKGROUND OF THE INVENTION

Existing recycling systems use a variety of techniques to incentivize individual users to recycle. Existing systems (such as RecycleBank, TOMRA, and Waste Management) use coupons and discount offerings on consumer packaged goods to encourage users to recycle more often and to recycle a larger volume of recyclable materials.

Some states having bottle bills (such as ME and CT) where consumers are required by law to pay a fee ($0.05 to $0.15) on beverage containers purchased. Only after returning the empty container to a redemption center (like CLYNK) or a reverse vending machine (made by TOMRA, Envipco, Can and Bottle Systems) does the user get his or her money back. Thus, there is a need for a recycling system where a user is incentivized via economic principles to increase his or her recycling rate. There is a need for a market driven method and system that will incentivize individual users economically to increase recycling rates.

Various existing systems, while providing teachings of recycling methods, however, do not achieve these objectives and do not provide a market driven method and system that will incentivize individual users economically to increase recycling rates.

For example, U.S. Pat. No. 6,811,030 to Compton et al. discloses a method for removing recyclables that allows for customer's accounts to be credited. The accounts can then be used to send money to charity.

U.S. Patent Publication No. 2007/0219862 to Casella et al. discloses a system and method for identifying and processing recyclables having a recycling tag and measuring and assessing the quality of goods while providing a benefit to the users associated with recyclable containers.

U.S. Patent Publication No. 2007/0260466 to Casella et al. discloses methods for a recycling program that include measuring the quantity and amount of recyclables and providing a user-specific diversion rate based on ratio of the recyclable materials to waste. Other prior art references also disclose recycling systems and methods.

However, none of the above mentioned patents and patent application, or any of the existing systems, disclose a market driven solution that is based on a revenue sharing model that will incentivize consumers to increase their personal recycling rates.

This is a desired object of the invention.

### SUMMARY OF THE INVENTION

Accordingly, it is an object of the present invention to provide a recycling system with a revenue sharing model that incentivizes users to increase their personal recycling rates.

It is another object of the invention to provide a method and system that has revenue sharing.

These and other objects of the invention are achieved by providing a method for recycling the recyclables of individual users comprising the steps of: transporting the recyclables to a drop-off facility; determining the quality and volume of the recyclables; densifying the recyclables to form densified recyclables; transporting the densified recyclables to a municipal recycling facility; processing the densified recyclables to form processed recyclables at the municipal recycling facility; determining the value of the processed recyclables; and sharing the value of the processed recyclables with the individual users via revenue sharing, the revenue sharing based upon providing the individual users with a percentage of the value of the processed recyclables based upon the amount and/or value of the recyclables contributed by each individual. The revenue sharing may be a revenue sharing model and/or algorithm. The value of the recyclables may be a net value or a gross value.

The method may further comprise the step of providing one or more containers for the recyclables to be deposited in. The transporting step may involve the recyclables being transported via the one or more containers. The one or more containers are individualized to each of the individual users via unique bar codes, and/or identification systems.

The method may further comprise the step of deducting operating and processing costs from the value of the processed recyclables prior to sharing the value of the processed recyclables with the individual users via the revenue sharing.

The step of transporting the recyclables to a drop off facility may be conducted by the individual users or by a third party collector. The step of revenue sharing may credit the individual users on a regular basis based upon a percentage of the value of the processed recyclables. The step of crediting the individual users may occur, weekly, bi-weekly, or monthly.

The revenue sharing step may credit the individual users on a regular basis based upon the volume and quality of recyclables each individual user contributed during a period prior to processing the densified recyclables. This may occur weekly, bi-weekly, or monthly.

The revenue sharing step may reward the individual users with coupons or credits for free merchandise. Coupons may be sent weekly, bi-weekly, or monthly. Coupons may also be sent once individual users have reached certain recycling goals.

The revenue sharing step may also allow for the individual users to be credited electronically via electronic accounts for each of the individual users. Such electronic accounts may be bank account or may be an account that is linked to the recycling method and system. The revenue sharing step may allow the individual users to assign a percentage of the value in their electronic accounts to charity. This may occur automatically and a tax report and receipt of the individual users may be printed, such that individual users receive tax credits and benefits.

The step of determining the value of the processed recyclables may involve using spot commodity pricing. The step of determining the value of the processed recyclables may involve using generally accepted market rates for various recyclable materials. Such rates are typically adjusted monthly based on industry supply and demand.

Other objects of the invention are achieved by providing a system for recycling the recyclables for individual users comprising: one or more containers for recyclables to be deposited; a densification apparatus, the densification apparatus for densifying the recyclables to form densified recyclables; a processor, the processor for processing the densified recyclables to form processed recyclables; and a computer, the computer for determining the value of the processed recyclables and for sharing the value of the processed recyclables with the individual users via revenue sharing. The revenue sharing may be a model and/or algorithm. The value of the recyclables may be a net value or a gross value.

The system may have one or more containers that are individualized to each of the individual users via unique bar codes.

The computer in the system may deduct operating and processing costs from the value of processed recyclables and may credit individual users on a regular basis based upon a percentage of the value of the processed recyclables.

The system may have the computer deduct operating and processing costs from the value of processed recyclables and may credit individual users on a regular basis based upon a percentage of the volume, quality and value of recyclables each individual user contributed to be processed by the processor.

The system may have the revenue sharing reward the individual users with coupons or credits for free merchandise. The system may have the individual users be credited electronically via electronic accounts for each of the individual users.

The system may have the revenue sharing allow the individual users to assign a percentage of the value in their account to charity. The system may have the computer, when determining the value of the processed recyclables use spot commodity pricing.

Other objects of the invention are achieved by providing a method for recycling the recyclables of individual users comprising the steps of: providing one or more containers for the recyclables to be deposited in; transporting the recyclables to a drop-off facility via the one or more containers; determining the quality and volume of the recyclables; densifying the recyclables to form densified recyclables; transporting the densified recyclables to a municipal recycling facility; processing the densified recyclables to form processed recyclables at the municipal recycling facility; determining the value of the processed recyclables; and sharing the value of processed recyclables with the individual users via revenue sharing, the revenue sharing crediting individual users on a regular basis based upon a percentage of the value of the processed recyclables. The revenue sharing may be a model and/or algorithm. The value of the recyclables may be a net value or a gross value.

The method may have the step of determining the quality and volume of the recyclables be done via an optical sensor. The method may further comprise the step of storing data in a computer, the data comprising customer ID data, transaction data, weight data, and scan quality data.

The method may further comprise the step of sorting the densified recyclables into bales of different materials.

The method step of determining the value of processed recyclables may be based upon calculating the price of different materials using pricing indices multiplied with the weight of the bales of the different materials.

The method may further comprise a step of deducting operating and/or processing costs from the value of the processed recyclables prior to sharing the value of the processed recyclables with the individual users via the revenue sharing.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a flowchart of an embodiment of the present invention;

FIG. 2 is a flowchart further expanding upon a step of the flowchart of FIG. 1;

FIG. 3 is a flowchart of the embodiment of FIG. 1 with an additional method step;

FIG. 4 is a flowchart of another embodiment of the present invention;

FIG. 5 is a flowchart further expanding upon a step of the flowchart of FIG. 1; and

FIG. 6 is a flowchart further expanding upon a step of the flowchart of FIG. 2;

FIG. 7 is a flowchart showing the system of an embodiment of the present invention relating to the flowchart shown in FIG. 1.

### DETAILED DESCRIPTION OF THE INVENTION

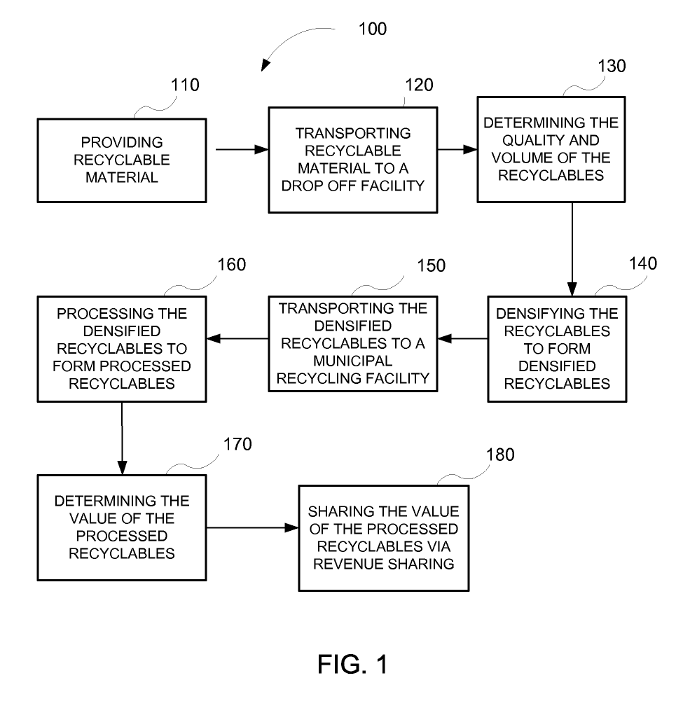

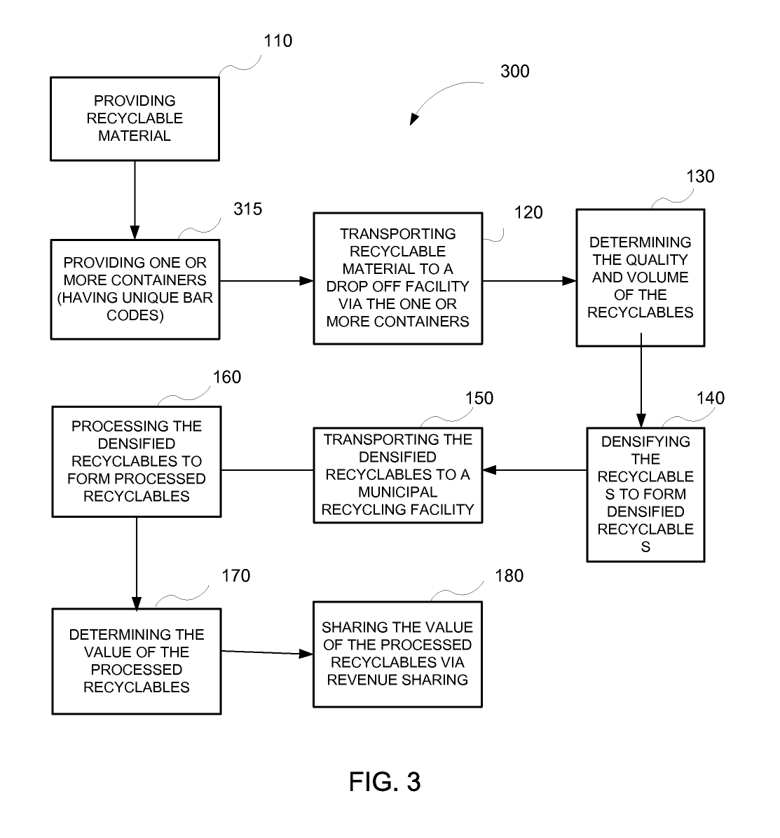

Referring to FIG. 1, a flowchart of an embodiment of the present invention is shown. Here step 110 is shown where recyclables are provided. Recyclable materials may be materials such as aluminum, plastics, white paper, fiberboard (CPG packaging), and other such materials known in the art that may be recycled. The materials are provided by consumers or individualized users. The materials may be transported via one or more containers having unique bar codes. This is shown as step 315 in the flowchart of FIG. 3. The one or more containers may be a reusable bag or other such container that can store or house recyclable materials.

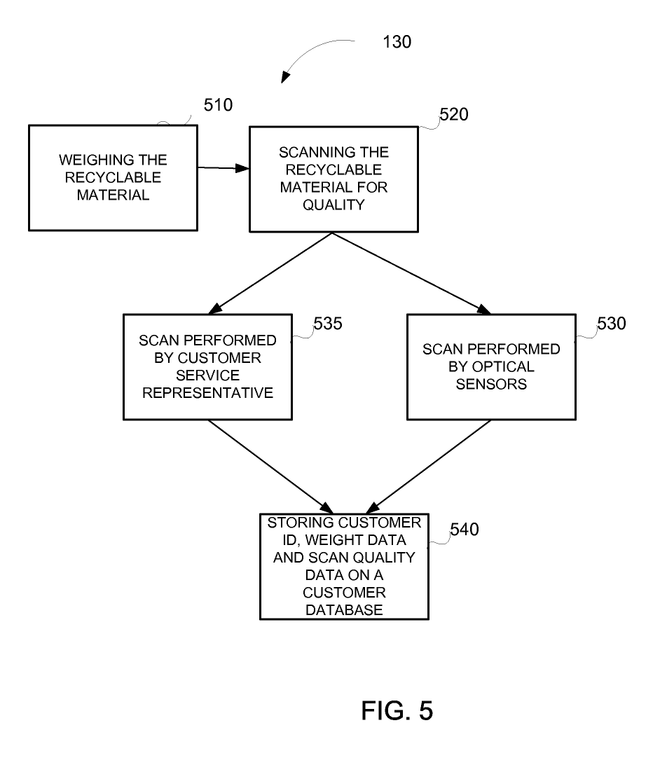

The next step shown in FIG. 1 is step 120, where the recyclable material is transported to a drop off facility. The recyclable material may be transported by a collection truck or the individualized user may transport the recyclable material in his or her own car. The next step 130 involves determining the quality and the volume of the recyclable materials. This is done at the drop off facility where the recyclable material is weighted and/or scanned for quality. This step is shown in FIG. 5 where the weighing step 510 is typically followed by scanning step 520. Scanning step 520 may occur manually, via a customer service representative 535, or may occur via optical sensors 530. In both cases, the steps involve transmitting information, such as the customer ID, weight data, and scan quality data to a computer or customer database. Such information is stored in the customer database or on the computer. This is shown as step 540.

The next step of the method is 140, which is a step to densify the recyclable material 140 to form densified recyclables or densified recyclable material. The densification step may involve conveying the recyclable material to a compactor. The compactor will densify, i.e., compact or compress the recyclable material. The densification step 140 allows large amounts of recyclable materials to be converted into densified recyclable materials, which contain less volume. It is easier and more cost efficient, to transport the densified recyclable materials and to store such materials in a compactor.

Once the compactor is full, the compactor is hauled by truck to a Material Recycling Facility. This is shown as step 150, which involves transporting the densified recyclables to a municipal recycling facility. This step can also be done by train or by a device which can transport a compactor.

Once at the material recycling facility (also known as a municipal recycling facility), the densified recyclable materials undergo the processing step 160. Processing step 160 involves sorting the densified recyclable materials into bales of separate materials. The densified recyclables form processed recyclables. Thus, the aluminum materials will be separated and sorted separately from other materials such as paper or fiber. The processing may occur manually or via automated robots or machinery.

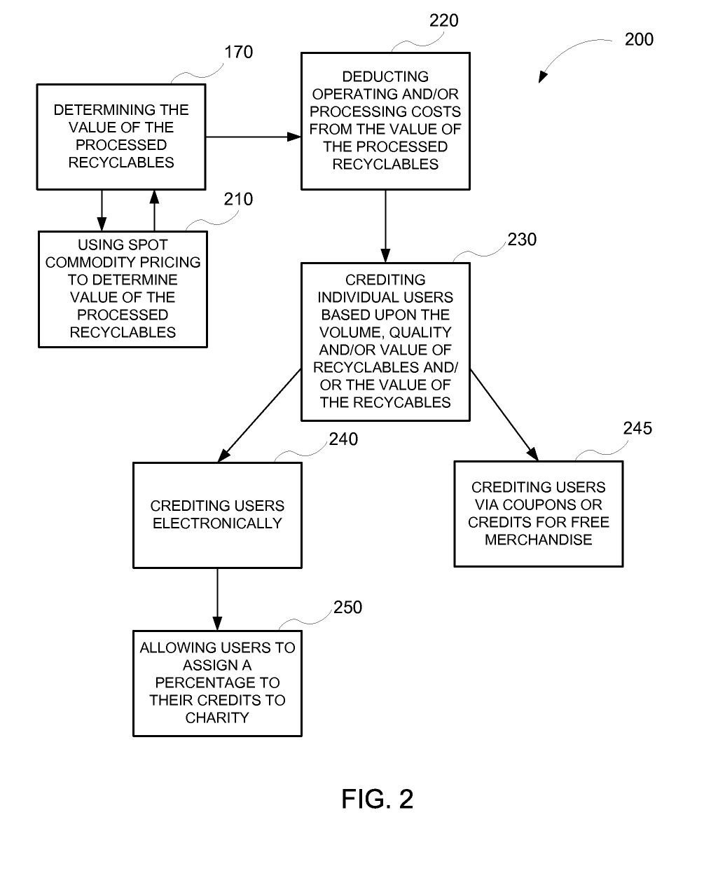

The next step involves determining the value of the processed recyclables 170. This step involves valuing the bales of aluminum, plastic, paper and fiber based on pricing indices used by the recycling industry. These prices are adjusted monthly. This is also shown in FIG. 2, where spot commodity pricing 210 is used to determine the value of the processed recyclable material.

Once the value of the recyclables has been established, the next step involves sharing the value of the processed recyclables via revenue sharing 170. This is shown in FIG. 2 where there the operating and/or processing costs are deducted from the value of the processed recyclables 220. The operating costs to collect and produce the bales will be deducted from the value (weight times $/lb).

The individualized users are then credited based upon the volume, quality and/or the value of the recyclable materials they contributed. This is for the time period that they contributed prior to processing at the municipal recycling facility, typically every two weeks. However, the time period that individualized users contribute may be weekly or even monthly.

The users may be credited electronically 240 into their bank accounts or accounts associated with the recycling system and method. Alternatively, users may also be credited via coupons or credits for free merchandise 245. Additionally, the users are optionally enabled to assign a percentage of their credits to a charity 250. These steps (220, 230, 240, 245 and 250) are all part of a revenue sharing system and method. It is an object of the invention to achieve this revenue sharing.

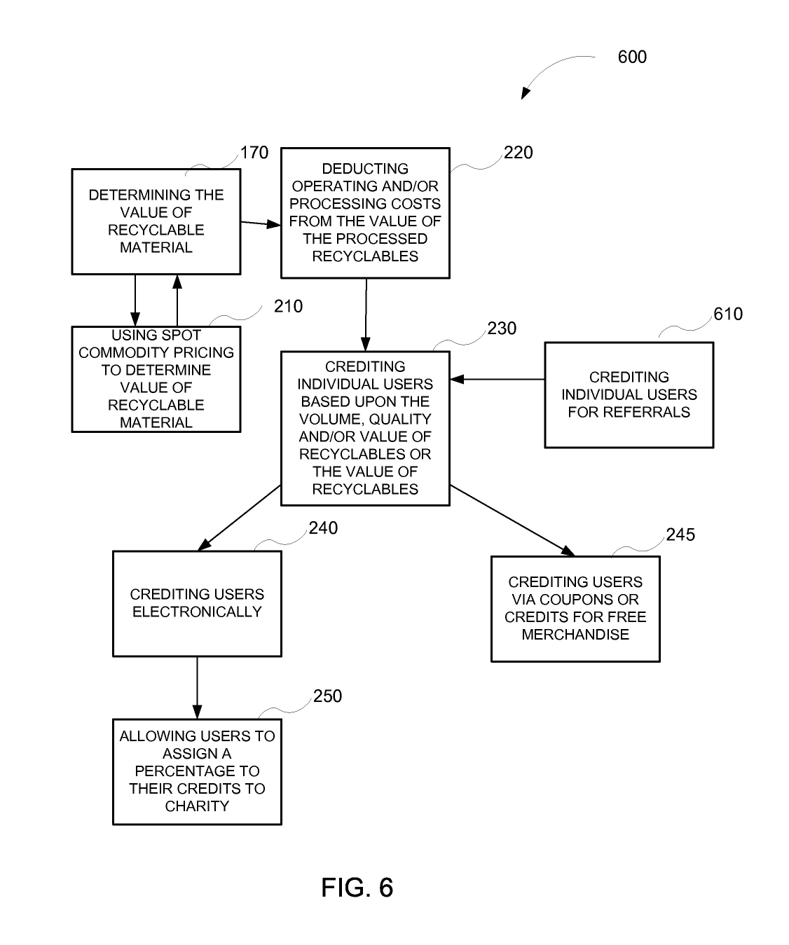

The revenue sharing may also involve having the users be credited for signing up friends and family to be part of the recycling system and method. This is shown in FIG. 6, where step 610 allows for crediting individuals for referrals is shown. The revenue sharing may credit a percentage of the value of a family account to a referring party. This will help incentivize people to refer others to the revenue sharing. Furthermore, revenue sharing may involve providing additional benefits to users such as having recycling meetings, social outings and other such incentives to further recycling causes and to increase economic and social incentives for individual users.

Referring to FIG. 3, the method and system of FIG. 1 is shown, however, an additional step is provided being that there are one or more containers (having unique bar codes) 315 that allow the recyclable material to be transported. This method further demonstrates that the containers having bar codes allows for the individual users to be tracked and allows for easy transport and delivery of recyclable materials.

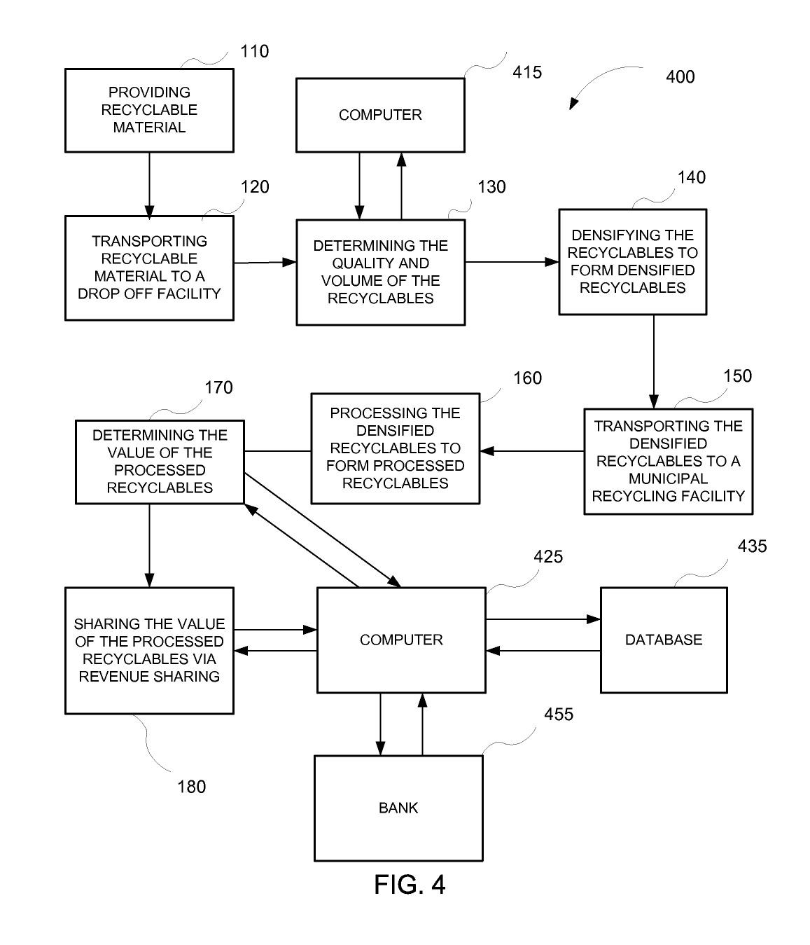

FIG. 4 shows the present method integrated with a computer and database system. Here, computer 415 is integrated with the step 130 for determining the quality and the volume of the recyclables. The computer 415 is used to store customer ID, transaction data (day & time), weight data, and scan quality data. Other information may be used and stored on this computer, which also may be linked to a database or other such storage system. Such information may be stored on a database that is located on a server and is connected over the internet.

FIG. 4 also shows computer 425 tied to the step 170 of determining the value of the processed recyclables as well as the step 180 of sharing the value of the processed recyclables via revenue sharing. The computer 425 is able to perform the calculations to divide up the amount of money for each individualized user based upon the volume and quality of materials the user contributed and/or well as the value of the materials the user contributed.

The computer 425 is shown linked to a database 435 and to a bank 455, having various bank accounts linked to individualized users. The computer can electronically transmit funds to the individual bank accounts of users. The computer may also issue coupons to frequent users or users that have hit various recycling milestones and levels. The computer can produce these coupons based upon a range of variables collected in the database.

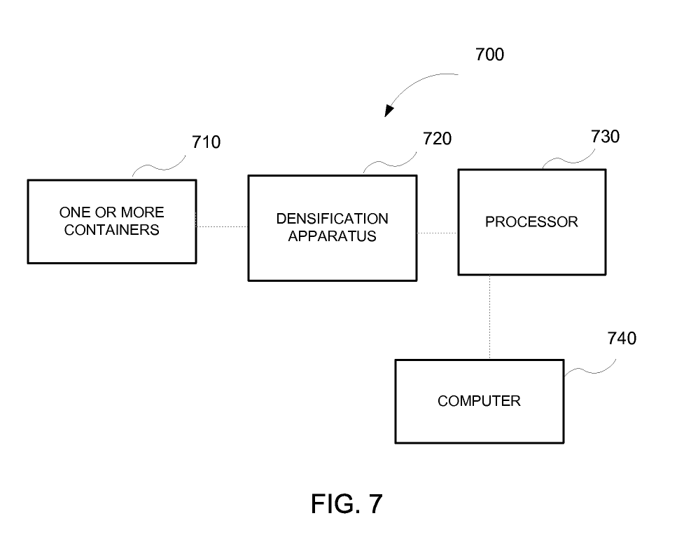

FIG. 7 shows system 700 having one or more containers 710, a densification apparatus 720, processor 730 and computer 740. Such a system is designed to perform the method and system described above.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention

1. A method for sharing revenue collected from the recyclables of individual users, the method comprising the steps of:
collecting the recyclables of individual users;
transporting the recyclables to a drop-off facility;
determining the quality and volume of the recyclables and storing data directed to the quality and volume of the recyclables on a computer or a database;
densifying the recyclables at the drop-off facility to form densified recyclables;
transporting the densified recyclables to a municipal recycling facility;
processing the densified recyclables to form processed recyclables at the municipal recycling facility;
determining the value of the processed recyclables; and
sharing the value of the processed recyclables with the individual users via revenue sharing, the revenue sharing based upon providing the individual users with a percentage of the value of the processed recyclables based upon the amount, quality and/or value of the recyclables contributed by each individual user,
wherein the revenue sharing is performed on the computer or the database, and
wherein processing costs are deducted from the value of the processed recyclables prior to sharing the value of the processed recyclables with the individual users via the revenue sharing.

2. The method of claim 1, further comprising a step of providing one or more containers for the recyclables to be deposited in and transporting the recyclables via the one or more containers.

3. The method of claim 1, wherein the one or more containers are individualized to each of the individual users via unique bar codes or identification systems.

4. (canceled)

5. The method of claim 1, wherein the step of transporting the recyclables to a drop off facility is conducted by the individual users or by a third party collector.

6. The method of claim 1, wherein the revenue sharing credits the individual users on a regular basis based upon a percentage of the value of the processed recyclables.

7. The method of claim 1, wherein the revenue sharing credits the individual users on a regular basis based upon the volume and quality of recyclables each individual user contributed during a period prior to processing the densified recyclables.

8. The method of claim 1, wherein the revenue sharing rewards the individual users with coupons or credits for free merchandise.

9. The method of claim 1, wherein the revenue sharing allows for the individual users to be credited electronically via electronic accounts for each of the individual users.

10. The method of claim 9, wherein the revenue sharing allows the individual users to assign a percentage of the value in their electronic accounts to charity.

11. The method of claim 1, wherein the step of determining the value of the processed recyclables involves using spot commodity pricing.

12. A system for recycling the recyclables for individual users comprising:
one or more containers for recyclables to be deposited;
a densification apparatus, the densification apparatus for densifying the recyclables to form densified recyclables;
a processor, the processor for processing the densified recyclables to form processed recyclables; and
a computer, the computer for determining the value of the processed recyclables and for sharing the value of the processed recyclables with the individual users via revenue sharing, the revenue sharing based upon providing the individual users with a percentage of the value of the processed recyclables based upon the amount, quality and/or value of the recyclables contributed by each individual user.

13. The system of claim 12, wherein the one or more containers are individualized to each of the individual users via unique bar codes.

14. The system of claim 12, wherein the computer deducts processing costs from the value of processed recyclables and credits individual users on a regular basis based upon a percentage of the value of the processed recyclables.

15. The system of claim 12, wherein the computer deducts operating and processing costs from the value of the processed recyclables and credits individual users on a regular basis based upon a percentage of the volume of recyclables each individual user contributed to be processed by the processor.

16. The system of claim 12, wherein the revenue sharing rewards the individual users with coupons or credits for free merchandise.

17. The system of claim 12, wherein the revenue sharing allows for the individual users to be credited electronically via electronic accounts for each of the individual users.

18. The system of claim 17, wherein the revenue sharing allows the individual users to assign a percentage of the value in their account to charity.

19. The system of claim 12, wherein the computer, when determining the value of the processed recyclables, uses spot commodity pricing.

20. A method for sharing revenue collected from recycling the recyclables of individual users, the method comprising the steps of:
collecting the recyclables of individual users via one or more containers;
transporting the recyclables to a drop-off facility via the one or more containers;
determining the quality and volume of the recyclables and storing data directed to the quality and volume of the recyclables on a computer or a database;
densifying the recyclables to form densified recyclables;
transporting the densified recyclables to a municipal recycling facility;
processing the densified recyclables to form processed recyclables at the municipal recycling facility;
determining the value of the processed recyclables; and
sharing the value of processed recyclables with the individual users via revenue sharing, the revenue sharing crediting individual users on a regular basis based upon a percentage of the value of the processed recyclables,
wherein the revenue sharing is performed on the computer or the database.

21. The method of claim 20, wherein the step of determining the quality and volume of the recyclables is done via an optical sensor.

22. The method of claim 20, wherein the data further comprises customer ID data, weight data, and scan quality data.

23. The method of claim 20, further comprising the step of sorting the densified recyclables into bales of different materials.

24. The method of claim 23, wherein the step of determining the value of processed recyclables is based upon calculating the price of different materials using pricing indices multiplied with the weight of the bales of the different materials.

25. The method of claim 20, further comprising deducting processing costs from the value of the processed recyclables prior to sharing the value of the processed recyclables with the individual users via the revenue sharing.
